(19) United States
(12) Patent Application Publication
(10) Pub. No.: US 2026/0156039 A1
(43) Pub. Date: Jun. 4, 2026

(54) OPTIMIZING ROUTING OF INTERCONNECTS USING MULTIPLE TOPOLOGIES

(71) Applicant: GDM Holding LLC, Mountain View, CA (US)

(72) Inventor: Cyrus Behroozi, Menlo Park, CA (US)

(21) Appl. No.: 19/455,989

(22) Filed: Jan. 22, 2026

Related U.S. Application Data
(63) Continuation of application No. PCT/US2025/039824, filed on Jul. 30, 2025.
(60) Provisional application No. 63/690,845, filed on Sep. 5, 2024.

(51) Int. Cl. H04L 41/12; H04L 45/02; H04L 45/122; H04L 49/109

(52) U.S. Cl. CPC H04L 41/12; H04L 45/08; H04L 45/122; H04L 49/109

(57) ABSTRACT

The technology involves optimization of routings of interconnects of a semiconductor device. According to an aspect, a method includes receiving a netlist corresponding to a routing of interconnects of a circuit to be fabricated. The routing of the interconnects is initialized using a first routing topology describing a first physical arrangement of the interconnects. Subsequent to initialization of the routing of the interconnects, the routing of the interconnects is optimized, according to a set of constraints, using a second routing topology describing a second physical arrangement of the interconnects. A circuit arrangement describing geometry of the interconnects according to the optimized routing of the interconnects is generated.

### CROSS REFERENCE TO RELATED APPLICATIONS

The present application is a continuation of International Application No. PCT/US2025/039824, filed Jul. 30, 2025, which claims the benefit of and priority to U.S. Provisional Application No. 63/690,845, filed Sep. 5, 2024, the entire disclosure of which is hereby incorporated herein by reference.

### BACKGROUND

Performance of a circuit (such as power requirements and/or consumption, timing, and/or size thereof) may be dependent on characteristics and/or arrangement of interconnects of the circuit. Interconnects of a circuit may include electrically conductive connections (e.g., metal wiring) between components (e.g., transistors) of the circuit. As sizes of and/or spaces between transistors and/or interconnects shrink, the cumulative resistance and/or cumulative capacitance (e.g., self-capacitance) of interconnects may approach the cumulative resistance and/or cumulative capacitance of transistors (e.g., transistors coupled to those interconnects), which can adversely impact performance of a circuit. Optimization of routings of interconnects may include attempting to minimize parasitic effects of interconnects (e.g., resistance and capacitance of interconnects). This may include deformation of the interconnects (e.g., wires) to find local optima. However, such approaches may be constrained by the routing topology, which can be inefficient and inhibit optimization.

### SUMMARY

The technology provides for optimization of routing of metal interconnects across multiple routing topologies (also referred to herein as “topologies”). In contrast to other approaches, aspects of the present disclosure enable optimization of routing of interconnects using more than one topology. Optimization of routing of interconnects may be based on a list of nets (e.g., a netlist), which may indicate locations of the terminals of a circuit and corresponding connectivity (e.g., connectivity graph). From this, multiple, if not all topologies of a circuit may be enumerated.

The technical benefits include optimization of one or more (including up to all) enumerated topologies of a circuit in parallel. For instance, a routing of interconnects may be initialized with a set of topologies (e.g., a subset of the enumerated topologies). Optimization of a routing of interconnects may include trying one or more different sets of topologies to yield an optimized routing of the interconnects. For example, within a respective topology, one or more characteristics of one or more of the interconnects describing the physical arrangement of the interconnects may be modified, so as to deform one or more of the interconnects, until a constraint associated with the optimization and/or the routing of the interconnects is encountered.

Combinational optimizations described herein may yield a more optimum arrangement (e.g., routing design) of interconnects than other approaches. Combinational optimization may include continuous optimization and combinatorial optimization. Different topologies may represent different combinatorial options (e.g., wire A crossing either over or under wire B, wire A crossing either over or under wire C, etc.). Within constraints of one or more combinations, at least one continuous optimization is performed. For example, wire A is deformed in a way to improve circuit performance until the deformation of wire A is limited by wire B. For a given topology, multiple continuous optimizations can be performed. For example, for a given topology, wire A is deformed in a way to improve circuit performance until the deformation of wire A is limited by wire B, and wire B is deformed in a way to improve circuit performance until the deformation of wire B is limited by wire C.

Continuous optimization approaches described herein may optimize a routing of interconnects that is initialized with a particular topology. Then, multiple other (different) topologies may be used to optimize the routing of the interconnects, each different topology providing a local optimum. For each of one or more of the topologies, continuous optimization approaches described herein may be used to provide a respective local optimum. Thus, by optimizing a routing of interconnects using multiple, different topologies, multiple local optima are obtained.

Because multiple, local optima can be obtained, the likelihood of finding a global optimum, based on those local optima, is increased. Optimizations of a routing of interconnects as described herein may provide an exhaustive search in which nearly every, or every, possible topology is used, even if only a few topologies are enumerated or available, and/or substantial computing resources are required. Thus, for each possible topology, the routing of the interconnects may be refined to a respective local optimum, which may guarantee that a global optimum for the routing of the interconnects is achieved.

According to one aspect of the technology, a method is provided comprising: receiving, by one or more processors, a netlist corresponding to a routing of interconnects of a circuit to be fabricated; initializing, by the one or more processors, the routing of the interconnects using a first routing topology describing a first physical arrangement of the interconnects; subsequent to initializing the routing of the interconnects using the first routing topology, optimizing, by the one or more processors according to a set of constraints, the routing of the interconnects using a second routing topology describing a second physical arrangement of the interconnects; and generating, by the one or more processors, a circuit arrangement describing geometry of the interconnects according to the optimized routing of the interconnects.

In an example, initializing the routing of the interconnects using the first routing topology may include determining a first local optimum for the routing of the interconnects. The first local optimum being associated with the first routing topology. Here, optimizing the routing of the interconnects using the second routing topology may include determining a second local optimum for the routing of the interconnects. The second local optimum may be associated with the second routing topology. A global optimum for the routing of the interconnects may be determined based on the first local optimum and the second local optimum.

Alternatively or additionally to the above, the method may include, prior to initializing the routing of interconnects using the first routing topology, enumerating, by the one or more processors, a plurality of routing topologies associated with the routing of the interconnects; and selecting, from the plurality of routing topologies, the first routing topology and the second routing topology for optimizing the routing of the interconnects. The plurality of routing topologies may include the first routing topology and the second routing topology. Each of the plurality of routing topologies may describe a respective physical arrangement of the interconnects.

Alternatively or additionally to the above, the method may include, at least partially in parallel with optimizing the routing of the interconnects using the second routing topology, optimizing, by the one or more processors, the routing of the interconnects using a third routing topology describing a third physical arrangement of the interconnects. Alternatively or additionally to the above, the method may include applying a distance metric associated with the first routing topology and the second routing topology to transition one or more of the interconnects from the first routing topology to the second routing topology. Here, the distance metric may be a Euclidean distance in a vector space representing a similarity of the first routing topology to the second routing topology.

Alternatively or additionally to the above, the method may include sampling the first routing topology and the second routing topology based on vector embedding. Alternatively or additionally to the above, the method may include, prior to optimizing the routing of the interconnects using the second routing topology, selecting the second routing topology from a plurality of routing topologies based on information from initializing the routing of the interconnects using the first routing topology. Optimizing the routing of the interconnects using the second routing topology may be based on a genetic algorithm. The circuit may be implemented on a field-programmable gate array (FPGA) device. The circuit may be an application-specific integrated circuit (ASIC) device or other IC-based device.

According to another aspect of the technology, a system is provided that comprises memory configured to store a plurality of routing topologies and a routing of interconnects of a circuit to be fabricated, and one or more processors operatively coupled to the memory. The one or more processors are configured to: receive a netlist corresponding to the routing of interconnects; initialize the routing of the interconnects using a first routing topology of the plurality of routing topologies, the first routing topology describing a first physical arrangement of the interconnects; subsequent to initialization of the routing of the interconnects using the first routing topology, optimize, according to a set of constraints, the routing of the interconnects using a second routing topology of the plurality of routing topologies, the second routing topology describing a second physical arrangement of the interconnects; and generate a circuit arrangement describing geometry of the interconnects according to the optimized routing of the interconnects.

In an example, the one or more processors may be configured to initialize the routing of the interconnects using the first routing topology by being configured to determine a first local optimum for the routing of the interconnects. The first local optimum may be associated with the first routing topology. Here, the one or more processors are configured to optimize the routing of the interconnects using the second routing topology by being configured to determine a second local optimum for the routing of the interconnects. The second local optimum may be associated with the second routing topology. The one or more processors may be further configured to determine a global optimum for the routing of the interconnects based on the first local optimum and the second local optimum.

Alternatively or additionally to the above, the one or more processors may be further configured to: prior to initialization of the routing of interconnects using the first routing topology, enumerate the plurality of routing topologies associated with the routing of the interconnects; and select, from the plurality of routing topologies, the first routing topology and the second routing topology for optimizing the routing of the interconnects. Alternatively or additionally to the above, the one or more processors may be further configured to optimize the routing of the interconnects using a third routing topology describing a third physical arrangement of the interconnects at least partially in parallel with the optimization of the routing of the interconnects using the second routing topology. Alternatively or additionally to the above, the one or more processors may be further configured to apply a distance metric associated with the first routing topology and the second routing topology to transition the one or more of the interconnects from the first routing topology to the second routing topology. Here, the distance metric may be a Euclidean distance in a vector space representing a similarity of the first routing topology to the second routing topology.

Alternatively or additionally to the above, the one or more processors may be further configured to sample the first routing topology and the second routing topology based on vector embedding. Alternatively or additionally to the above, the one or more processors may be further configured to, prior to optimization of the routing of the interconnects using the second routing topology, select the second routing topology from the plurality of routing topologies based on information from initializing the routing of the interconnects using the first routing topology. Alternatively or additionally to the above, the one or more processors may be further configured to optimize the routing of the interconnects using the second routing topology is based on a genetic algorithm. The circuit may be implemented on a field-programmable gate array (FPGA) device. The circuit may be an application-specific integrated circuit (ASIC) device or other IC-based device.

### BRIEF DESCRIPTION OF THE DRAWINGS

FIG. 1 illustrates an integrated circuit design flow in accordance with aspects of the technology.

FIG. 2 illustrates an example system that may be employed with aspects of the technology.

FIG. 3 illustrates an example method in accordance with aspects of the technology.

### DETAILED DESCRIPTION

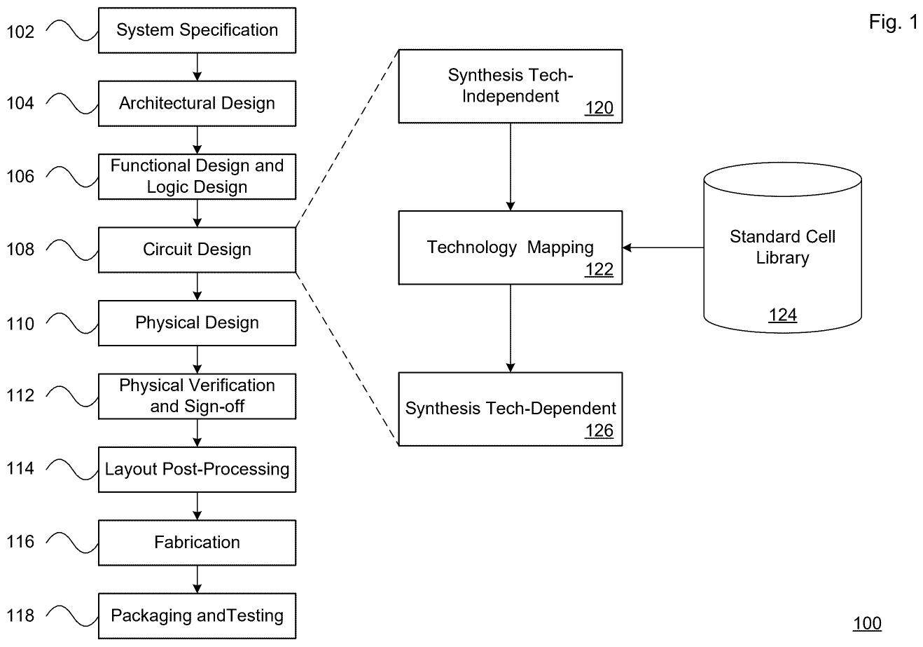

FIG. 1 illustrates an exemplary integrated circuit design flow 100 for use with aspects of the technology, including generating a circuit design and/or fabricating an integrated circuit that incorporates optimization of interconnects. As shown, the design flow may include preparing a system specification at block 102, such as to identify system-level requirements for the integrated circuit. The system specification is intended to capture the overall goal of the desired integrated circuit. This may include determining the device's cost, performance, general architecture, how off-chip communication will be conducted, etc. The process flow may also include performing architectural design at block 104. At this stage, the design's architecture and its layout are determined by design engineers. This can include integration of memory management, analog and/or mixed-signal components, on-device and external communication, any power constraints, choice of process technology and/or layer stacks, etc.

The process flow continues with performing functional design and logic design at block 106, and performing circuit design at block 108. Functional design may include refinement of the design's specification to achieve the functional behavior of the desired system. Logic design involves adding the design's structure to a behavioral representation of the desired design. Here, considerations include logic minimization, performance enhancement, as well as testability. This stage may consider problems associated with test vector generation, error detection and correction, and the like. By way of example, the functional design and logic design may include generating a behavioral model description (e.g., using HDL) and floor-planning. During circuit design, logic blocks are replaced by corresponding electronic circuits, which may include devices such as resistors, capacitors, and/or transistors. At this stage, circuit simulation may be performed in order to verify timing behavior and other constraints of the system. A Spice tool or other program may be used for circuit simulation.

Once the circuit design is complete, physical design may be performed at block 110 (e.g., component and wiring placement and routing), followed by physical verification and sign-off at block 112 (e.g., to obtain GDSII information with shapes to form the masks used to create the layers for fabricating the integrated circuit). During physical design, the actual layout of the integrated circuit is performed. Here, all of the components are placed and interconnected using metal interconnections. A circuit design that is able to pass testing of a circuit simulator in the circuit design stage may be found to be faulty after it has been packaged, e.g., due to geometric design rule issues. Thus, physical design rules are followed to ensure correctness during chip fabrication. Errors may include short or open circuits, open channels, or other issues may result when physical design rules are not followed. During physical verification and sign-off, the system performs any verification steps that are required before chip manufacturing. This can include design rule checking and correction, timing simulation, electromagnetic simulation, etc.

Layout post-processing occurs at block 114, then fabrication at block 116, and the packaging and testing at block 118. At block 114, the layout post-processing may include geometry processing before actual manufacturing, e.g., any dummy fill insertion, correction for optical proximity, mask optimization, etc. Fabrication comprises semiconductor manufacturing, which includes stages such as lithography patterning (masking), baking or annealing, etching, etc. Then the raw die of the chip is inserted into a package and I/O pins are connected to the package at block 118. Testing of the chip also occurs at this stage.

As shown, in the circuit design phase of block 108, the process may involve technology-independent synthesis at block 120. This step involves transferring the circuit definitions, such as register-transfer-level (RTL) descriptions, into generic data structures such as And-inverter graph (AIG), and optimizing the circuit in terms of nodes and levels. At block 122, technology mapping is performed based on information from a standard cell library 124. This step involves maps the generic optimized AIG descriptions into real, manufacturable standard cells included in the standard cell library. From this, technology-dependent synthesis is then performed at block 126. This step further optimizes the circuit defined in the gate-level netlist in terms of power, performance and area, using standard-cell-based definitions from block 122.

### Example Integrated Circuit Development System

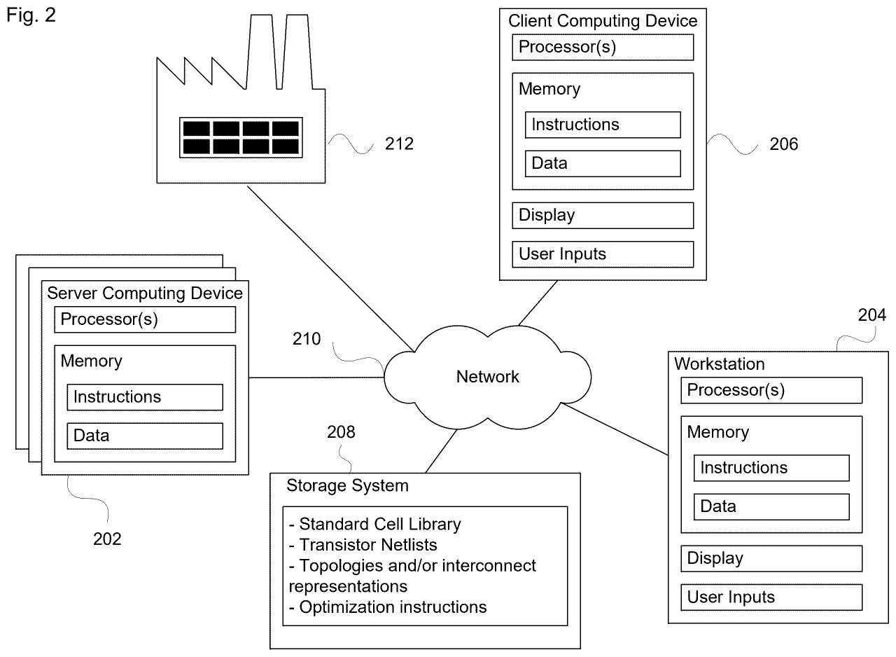

One example of a system for performing circuit design is shown in FIG. 2. In particular, FIG. 2 is a functional diagram, of an example system 200 that includes a plurality of computing devices 202, 204 and 206 and a storage system 208 connected via a network 210. System 200 may also include a fabrication facility 212 that is configured to produce integrated circuits designed according to the processes described herein. As shown in FIG. 2, each of computing devices 202, 204 and 206 may include one or more processors, memory, data and instructions.

By way of example, the one or more processors may be any conventional processors, such as commercially available central processing units (CPUs), graphical processing units (GPUs) or tensor processing unites (TPUs). Alternatively, the one or more processors may include a dedicated device such as an ASIC or other hardware-based processor. As shown in FIG. 2, the memory for each computing device stores information accessible by the one or more processors, including instructions and data that may be executed or otherwise used by the processor(s). The memory may be of any type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

Moreover, reference to “one or more processors” herein includes situations where a set of processors may be configured to perform one or more operations. Any combination of such a set of processors may perform individual operations or a group of operations. This may include two or more CPUs, GPUs or TPUs (or other hardware-based processors) or any combination thereof. It may also include situations where the processors have multiple processing cores. Therefore, reference to “one or more processors” does not require that all processors (or cores) in the set must each perform all of the operations. Rather, unless expressly stated, any one of the one or more processors (or cores) may perform different operations when a set of operations is indicated, and different processors (or cores) may perform specific operations, either sequentially or in parallel.

The instructions may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. The instructions may include a method for an optimization of interconnects as discussed herein.

The data may be retrieved, stored or modified by processor in accordance with the instructions. For instance, although the claimed subject matter is not limited by any particular data structure, the data may be stored in computing device registers, in a relational database as a table having a plurality of different fields and records, XML documents or flat files, HDL information, GDSII information, etc. The data may also be formatted in any computing device-readable format.

The computing devices may include all of the components normally used in connection with a computing device such as the processor and memory described above as well as a user interface having one or more user inputs (e.g., one or more of a button, mouse, keyboard, touch screen, gesture input and/or microphone), various electronic displays (e.g., a monitor having a screen or any other electrical device that is operable to display information), and speakers. The computing devices may also include a communication system having one or more wired or wireless connections to facilitate communication with other computing devices of system 200 and/or the fabrication facility 212.

The various computing devices may communicate directly or indirectly via one or more networks, such as network 210. The network 210 and any intervening nodes may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 202 may include one or more server computing devices having a plurality of computing devices, e.g., a load balanced server farm or cloud computing architecture, which exchange information with different nodes of a network for the purpose of receiving, processing, and transmitting the data to and from other computing devices. For instance, computing device 202 may include one or more server computing devices that are capable of communicating with computing devices 204, 206 and the fabrication facility 212 via the network 210. In some examples, client computing device 204 may be an engineering workstation used by a developer to perform circuit design and/or other processes for integrated circuit design and fabrication. Client computing device 206 may also be used by a developer, for instance to prepare system requirements for the integrated circuit or manage the manufacturing process with the fabrication facility 212.

Storage system 208 can be of any type of computerized storage capable of storing information accessible by the server computing devices 202, 204 and/or 206, such as a hard-drive, memory card, ROM, RAM, DVD, CD-ROM, flash drive and/or tape drive. In addition, storage system 208 may include a distributed storage system where data is stored on a plurality of different storage devices which may be physically located at the same or different geographic locations. Storage system 208 may be connected to the computing devices via the network 210 as shown in FIG. 2, and/or may be directly connected to or incorporated into any of the computing devices.

Storage system 208 may store various types of information. For instance, the storage system 208 may store a plurality of topologies and/or a routing of interconnects of a circuit to be fabricated, as well as instructions for performing optimizations and other processes described herein.

### Optimization of Interconnects

A routing of interconnects may be optimized to reduce, or minimize, certain parameters of the interconnects (e.g., parasitic characteristics including, but not limited to, a cumulative resistance, self-capacitance and/or coupling capacitance of the interconnects). For each topology used in the optimization, respective resistance, self-capacitance and/or coupling capacitance of each individual interconnect may be summed in a merit function, to provide a cumulative merit value or loss. Optimization of a routing of interconnects can include increasing or maximizing a merit value and/or decreasing or minimizing a merit loss. A cumulative merit value, for example, may be used to determine a local optimum for the topology.

Optimization of routing of one or more critical interconnects (e.g., associated with critical paths) may be prioritized over optimization of routing other interconnects. As used herein, “critical path” can refer to the slowest group of transistors and its associated interconnects in a circuit. Often, certain input-to-output paths of a circuit may propagate faster than other input-to-output paths of that circuit. One of those input-to-output paths can limit the overall performance (e.g., speed, timing) of the circuit. A critical path may include a sequence of particular transistors and interconnects. Interconnects of a critical path can be prioritized at the expense of non-critical paths of the circuit (e.g., input-to-output paths that do not limit the overall performance of the circuit). For instance, one or more non-critical paths may be detoured and/or incur an increase in parasitic characteristics so that one or more critical paths can take a more direct path, which can improve the overall performance of the circuit.

For example, by applying respective contributions of the critical interconnects to a merit function, optimization of parasitic characteristics of critical interconnects can be prioritized over optimization of parasitic characteristics of other, non-critical interconnects. For example, parasitic characteristics of critical interconnects may be reduced, as a result of optimization, at the cost of lesser or no reduction of parasitic characteristics of non-critical interconnects as a result of optimization.

Enumerated routing topologies of a circuit may be organized according to a distance metric that is indicative of a respective similarity of one topology to another topology. A topology may be “embedded” in a vector space. For example, an analogous approach is used in natural language processing (NLP) for vector embedding of words. The distance metric may be the Euclidean distance in such a vector space to assess and represent similarity of two or more topologies. For example, a topology that is identical to another topology except for one interconnect crossing over another interconnect, instead of the interconnect going under the other interconnect, may have a short distance metric that is indicative of the high similarity of those two topologies. A distance metric associated with a routing topology and another routing topology can be applied to transition one or more of interconnects from one routing topology to the other routing topology. Transitioning to another routing topology can include initializing an interconnect with a different starting position according to the other routing topology.

Vector embedding may be used to sampling multiple different topologies. Vector embedding may ensure that samples from the topologies are not from the same region of vector space. Vector embedding may be used for intentionally sampling candidate topologies near (e.g., similar to) a best known topology. For example, each component of a vector may be an ordinal value associated with a given choice of topology. For instance, the ordinal first choice of topology is whether wire A crosses under wire B (value of 0) or wire A crosses over wire B (value of 1). Other choices of topology (e.g., the ordinal second choice of topology, the ordinal third choice of topology, etc.) may be associated with other components of the vector.

After optimization of a routing of interconnects using a given topology has achieved a local optimum, information, including that local optimum, can be used to transition (also referred to as “jump”) the optimization to another topology (e.g., an adjacent topology). For instance, after completing optimization routing of interconnects using one or more topologies, the optimization may continue using another topology including a different crossing of interconnects and information obtained from the prior optimization.

By way of example, an optimization of a routing of interconnects may begin with constraints of a netlist corresponding to the routing of the interconnects, such as locations of terminals, members of each net, and routing resources (e.g., single plane, multiple metal layers with via connections). For these constraints, permutations for one or more nets can be described. Some primitives may have a small number of options for routing, and can then build a whole set of permutations.

For a given topology, an interconnect can be deformed (e.g., deformed continuously) until a constraint is met and/or a local optimum for that topology is achieved. For instance, if one or more objectives of an optimization are not further improved (e.g., a cumulative resistance and/or a cumulative capacitance of the routing of the interconnects is not further improved), then one or more optimization of the routing of the interconnects may continue using a different topology.

By way of example, an optimization of a routing of interconnects may use one or more genetic algorithms. Different options for crossings at intersections of the interconnects may be treated as genetic mutations in a genetic algorithm. Genetic algorithms are used to solve problems in which the solutions can be described by a set of variables and where solutions can be evaluated by predetermined metrics. There are functional equivalents to genetic algorithms, such as parameters of topologies, which may be categorized as heuristic approaches. Heuristic approaches use information gathered from attempted solutions to guide future solution attempts towards optimality. This differs from a brute force approach that tries all possible permutations of a problem's solution space to determine the optimal solution. Given that system architectures are often highly complex, brute force approaches to optimizing routings of interconnects using multiple topologies may be computationally infeasible. However, heuristics can be used to optimize routings of interconnects using multiple topologies with less computation time than a brute force approach. A genetic algorithm may use parameters of one or more topologies that resulted in successful optimization (e.g., improved cumulative resistance and/or cumulative capacitance) of the routing of the interconnects to identify one or more other topologies to use in optimizing the routing of the interconnects.

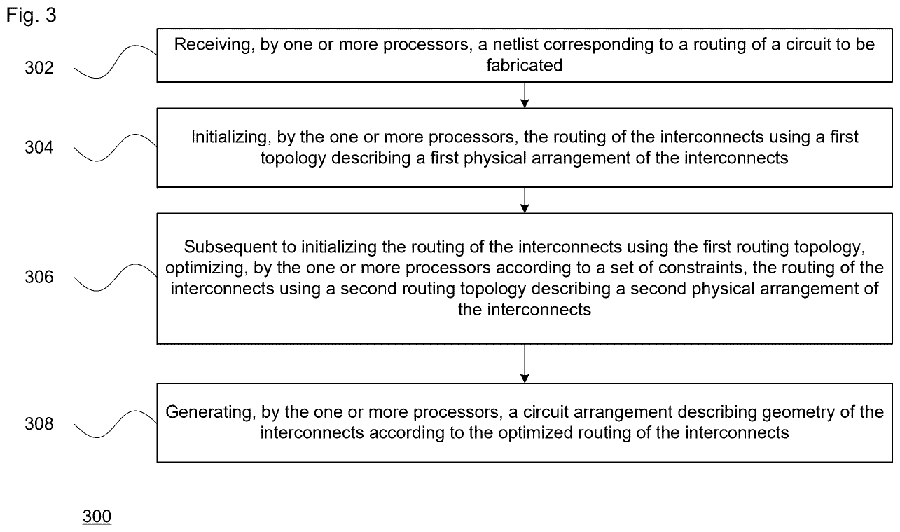

FIG. 3 illustrates an example method 300 in accordance with the above discussion. The method 300 includes, at block 302, receiving, by one or more processors, a netlist corresponding to a routing of interconnects of a circuit to be fabricated. At block 304, the method 300 includes initializing, by the one or more processors, the routing of the interconnects using a first routing topology describing a first physical arrangement of the interconnects. At block 306, the method 300 includes, subsequent to initializing the routing of the interconnects using the first routing topology, optimizing, by the one or more processors according to a set of constraints, the routing of the interconnects using a second routing topology describing a second physical arrangement of the interconnects. At block 308, the method 300 includes generating, by the one or more processors, a circuit arrangement describing geometry of the interconnects according to the optimized routing of the interconnects.

Although the technology herein has been described with reference to particular embodiments and configurations, it is to be understood that these embodiments and configurations are merely illustrative of the principles and applications of the present technology. It is therefore to be understood that numerous modifications may be made to the illustrative embodiments and configurations, and that other arrangements may be devised without departing from the spirit and scope of the present technology as defined by the appended claims.

1. A method, comprising:
receiving, by one or more processors, a netlist corresponding to a routing of interconnects of a circuit to be fabricated;
initializing, by the one or more processors, the routing of the interconnects using a first routing topology describing a first physical arrangement of the interconnects;
subsequent to initializing the routing of the interconnects using the first routing topology, optimizing, by the one or more processors according to a set of constraints, the routing of the interconnects using a second routing topology describing a second physical arrangement of the interconnects; and
generating, by the one or more processors, a circuit arrangement describing geometry of the interconnects according to the optimized routing of the interconnects.

2. The method of claim 1, wherein initializing the routing of the interconnects using the first routing topology includes determining a first local optimum for the routing of the interconnects, the first local optimum being associated with the first routing topology.

3. The method of claim 2, wherein optimizing the routing of the interconnects using the second routing topology includes determining a second local optimum for the routing of the interconnects, the second local optimum being associated with the second routing topology.

4. The method of claim 3, further comprising determining a global optimum for the routing of the interconnects based on the first local optimum and the second local optimum.

5. The method of claim 1, further comprising:
prior to initializing the routing of interconnects using the first routing topology, enumerating, by the one or more processors, a plurality of routing topologies associated with the routing of the interconnects, the plurality of routing topologies including the first routing topology and the second routing topology, each of the plurality of routing topologies describing a respective physical arrangement of the interconnects; and
selecting, from the plurality of routing topologies, the first routing topology and the second routing topology for optimizing the routing of the interconnects.

6. The method of claim 1, further comprising, at least partially in parallel with optimizing the routing of the interconnects using the second routing topology, optimizing, by the one or more processors, the routing of the interconnects using a third routing topology describing a third physical arrangement of the interconnects.

7. The method of claim 1, further comprising applying a distance metric associated with the first routing topology and the second routing topology to transition one or more of the interconnects from the first routing topology to the second routing topology.

8. The method of claim 7, wherein the distance metric is a Euclidean distance in a vector space representing a similarity of the first routing topology to the second routing topology.

9. The method of claim 1, further comprising sampling the first routing topology and the second routing topology based on vector embedding.

10. The method of claim 1, further comprising, prior to optimizing the routing of the interconnects using the second routing topology, selecting the second routing topology from a plurality of routing topologies based on information from initializing the routing of the interconnects using the first routing topology.

11. The method of claim 1, wherein optimizing the routing of the interconnects using the second routing topology is based on a genetic algorithm.

12. The method of claim 1, wherein the circuit is implemented on a field-programmable gate array (FPGA) device or an application-specific integrated circuit (ASIC) device.

13. A system, comprising:
memory configured to store a plurality of routing topologies and a routing of interconnects of a circuit to be fabricated; and
one or more processors operatively coupled to the memory, the one or more processors being configured to:
receive a netlist corresponding to the routing of interconnects;
initialize the routing of the interconnects using a first routing topology of the plurality of routing topologies, the first routing topology describing a first physical arrangement of the interconnects;
subsequent to initialization of the routing of the interconnects using the first routing topology, optimize, according to a set of constraints, the routing of the interconnects using a second routing topology of the plurality of routing topologies, the second routing topology describing a second physical arrangement of the interconnects; and
generate a circuit arrangement describing geometry of the interconnects according to the optimized routing of the interconnects.

14. The system of claim 13, wherein the one or more processors are configured to initialize the routing of the interconnects using the first routing topology by being configured to determine a first local optimum for the routing of the interconnects, the first local optimum being associated with the first routing topology.

15. The system of claim 14, wherein the one or more processors are configured to optimize the routing of the interconnects using the second routing topology by being configured to determine a second local optimum for the routing of the interconnects, the second local optimum being associated with the second routing topology.

16. The system of claim 15, wherein the one or more processors are further configured to determine a global optimum for the routing of the interconnects based on the first local optimum and the second local optimum.

17. The system of claim 13, wherein the one or more processors are further configured to:
prior to initialization of the routing of interconnects using the first routing topology, enumerate the plurality of routing topologies associated with the routing of the interconnects; and
select, from the plurality of routing topologies, the first routing topology and the second routing topology for optimizing the routing of the interconnects.

18. The system of claim 13, wherein the one or more processors are further configured to optimize the routing of the interconnects using a third routing topology describing a third physical arrangement of the interconnects at least partially in parallel with the optimization of the routing of the interconnects using the second routing topology.

19. The system of claim 13, wherein the one or more processors are further configured to apply a distance metric associated with the first routing topology and the second routing topology to transition the one or more of the interconnects from the first routing topology to the second routing topology.

20. The system of claim 13, wherein the one or more processors are further configured to sample the first routing topology and the second routing topology based on vector embedding.

21. The system of claim 13, wherein the one or more processors are further configured to, prior to optimization of the routing of the interconnects using the second routing topology, select the second routing topology from the plurality of routing topologies based on information from initializing the routing of the interconnects using the first routing topology.

22. The system of claim 13, wherein the one or more processors are further configured to optimize the routing of the interconnects using the second routing topology is based on a genetic algorithm.
